(19) United States
(12) Patent Application Publication
(10) Pub. No.: US 2005/0193013 A1
(43) Pub. Date: Sep. 1, 2005

(54) Method for evaluating semiconductor device

(75) Inventors: Kyoji Yamashita, Kyoto (JP); Katsuhiro Ohtani, Nara (JP); Atsuhiro Kajiya, Hyogo (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 10/991,457

(22) Filed: Nov. 19, 2004

(30) Foreign Application Priority Data
Feb. 16, 2004 (JP) 2004-038898

(51) Int. Cl. G06F 7/00

(52) U.S. Cl. 707/104.1

(57) ABSTRACT

A first relational expression representing a relationship among gate bias V_{d}, carrier mobility μ, electric effective channel length L_{eff} and transconductance Gₘ, and a second relational expression representing a relationship among maximum-transconductance ratio G_{mmax L=Lref}/G_{mmax L=Ltar} between a target transistor and a reference transistor and electric effective channel lengths L_{eff} and L_{ref} of the respective transistors are used. Maximum transconductance Gₘₘₐₓ obtained when gate bias V_{d} is changed is determined and electric effective channel length L_{eff} is estimated by substituting the value of maximum transconductance Gₘₘₐₓ in the second relational expression. The correlation between 1/Gₘₘₐₓ and L_{gsem} is strong enough to allow maximum transconductance Gₘₘₐₓ to be used in monitoring a process variation of a physical gate length.

### CROSS-REFERENCE TO RELATED APPLICATION

This application of Japanese Patent Application No. 2004-038898 filed on Feb. 16, 2004 including specification, drawings and claims is incorporated herein by reference in its entirety.

### BACKGROUND OF THE INVENTION

The present invention relates to a method for evaluating a semiconductor device. The method is used to estimate a physical gate length of a MIS transistor based on electric characteristics of the MIS transistor.

The physical gate length of a MIS transistor is an important parameter for evaluating performance and processing conditions of a semiconductor device. The drain current and threshold voltage of a MIS transistor and variations in semiconductor-circuit performance, for example, largely depend on the gate length, and therefore the gate length needs to be accurately evaluated. In view of this, in development of a CMOS device, gate length L of a transistor to be measured is evaluated by measurement using a scanning electron microscope (SEM). However, it is difficult to evaluate all the measurement patterns by actual measurement because of time constraints.

On the other hand, in manufacturing management, dimensions are monitored using rocket marks. However, it is difficult to obtain gate lengths in various transistor sizes in a chip and data on variations within a wafer surface/chip surface. If a technique for enabling evaluation of a physical gate length from electric characteristics of a wafer completed as a sample is established, this technique is useful for simplifying device development, evaluating variations in a manufacturing process and specifying causes of failure. The physical gate length is also referred to as “an electric gate length” because this length is estimated from electric characteristics.

As a technique for evaluating an electric gate length, a Shift and Ratio (S&R) method disclosed in, for example, reference 1 (IEEE transactions on Electron Device, Vol. 47, No. 1, January 2000, 160-169) is generally used. The S&R method is a technique for determining electric effective channel length L_{eff} based on the assumption that electric effective channel length L_{eff} is proportional to channel resistance R_{ch}. With the S&R method, source/drain parasitic resistance R_{sd} is also estimated by calculation (hereinafter also simply referred to as “estimated”.) Therefore, use of the S&R method in development of a semiconductor device is very effective. Hereinafter, general concepts of the S&R method will be described.

FIG. 13 is an illustration for explaining definitions of dimensions regarding a gate electrode of a MIS transistor. In FIG. 13, Lₘₐₛₖ is the size of an etching mask used for patterning the gate electrode, L_{gate} is an electric gate length, Lₘₑₜ is the metallurgical distance between pn junctions in a region between source and drain, and L_{eff} is an electric effective channel length.

FIG. 14 is a diagram showing an equivalent circuit including a MIS transistor in consideration of parasitic resistances of drain and source. Total resistance Rₜₒₜ in the circuit shown in FIG. 14 is given by the following equations (1) and (2):

$$\begin{matrix}{R}_{tot ( Vg )} = {V}_{d}^{′} / {I}_{d} & ( 1 ) \\ = {R}_{sd} + {R}_{ch} & ( 2 )\end{matrix}$$

where I_{d} is drain current, V_{d} is a drain voltage, R_{sd} is a total parasitic resistance of source and drain and R_{ch} is a channel region in a linear region.

FIG. 15 is a graph showing the dependence of total resistance Rₜₒₜ on the gate length. As shown in FIG. 15, total resistance Rₜₒₜ is proportional to electric gate length L_{gate}. In FIG. 15, an intersection point P of three lines L1 through L3 associated with different gate biases V_{g} indicates that Rₜₒₜ=R_{sd}, i.e., electric effective channel length L_{eff}=L_{gate}−ΔL=0. In this case, R_{sd} is about 200 Ωμm and ΔL is about 0.04 μm.

Ideally, the current-voltage characteristic in the linear region is given by the following equation (3):
I_{d}=W·μ_{eff}·Cₒ{(V_{g}−Vₜₕ)V_{d}−(1/2)V_{d}²} (3)
In a low drain bias region, the second term in Equation (3) can be disregarded, so that Rₜₒₜ is given by the following equation (4):
R_{tot(Vg)}=R_{sd}+[L_{eff}/{μ_{eff}·Cₒ·W(V_{g}−Vₜₕ)}] (4)
where μ_{eff} is effective carrier mobility, Cₒ is a capacitance of a gate oxide film, W is a gate width, V_{d} and V_{g} are a drain voltage and a gate bias, respectively, of a MIS transistor and Vₜₕ is a threshold voltage. If Equation (3) is generalized on the assumption that R_{ch} is proportional to electric effective channel length L_{eff} and is a function of (V_{g}−Vₜₕ), the following equation (5) is established
R_{tot(Vg)}=R_{sd}+L_{eff}·f(V_{g}−Vₜₕ) (5)
The dependence of parasitic resistance R_{sd} on gate bias (V_{g}) is small. Accordingly, suppose parasitic resistance R_{sd} is not a function of gate bias (V_{g}), both sides of Equation (5) are differentiated with respect to V_{g}, and then Equations (6) and (7) from which an influence of parasitic resistance R_{sd} is removed are obtained as follows:

$$\begin{matrix}\begin{matrix}{S}_{( Vg )}^{i} = \frac{ⅆ {R}_{tot}^{i}}{ⅆ {V}_{g}} \\ = {L}_{eff}^{i} \cdot \frac{ⅆ f ( {V}_{g} - {V}_{th}^{i} )}{ⅆ {V}_{g}}\end{matrix} & ( 6 ) \\ \begin{matrix}{S}_{( Vg )}^{O} = \frac{ⅆ {R}_{tot}^{0}}{ⅆ {V}_{g}} \\ = {L}_{eff}^{0} \cdot \frac{ⅆ f ( {V}_{g} - {V}_{th}^{0} )}{ⅆ {V}_{g}}\end{matrix} & ( 7 )\end{matrix}$$

where superscript i means a target device and superscript 0 means a reference device.

In Equations (6) and (7), suppose Vⁱₜₕ=V⁰, df(V_{g}−Vⁱₜₕ)/dV_{g}=df(V_{g}−V⁰ₜₕ)/dV_{g}, ratio Sⁱ/S⁰ is equal to Lⁱ_{eff}/L⁰_{eff}.

In the S&R method, a shift corresponding to ΔVₜₕ (the difference in Vₜₕ) is provided such that ratio r(S⁰=Sⁱ) with respect to S(=dRₜₒₜ/dV_{g}) between the target device and the reference device is constant, i.e., functions f(V_{g}−Vₜₕ) of the dependences of channel resistances on gate biases (V_{g}) in these devices are the same, and then a simple proportion, r=L⁰_{eff}/Lⁱ_{eff}, is established, thereby determining electric effective channel length L_{eff}. ΔVₜₕ is determined by statistical calculation. Since Rₜₒₜ is given by V_{d}/I_{d}, only data on the I_{d}−V_{g} characteristic in the linear region of the MIS transistor is needed. For the foregoing description, see reference 1, reference 2 (Proc. of IEDM, 1999, pp. 827-830) and reference 3 (Proc. of IEDM, 2002, pp. 117-120).

Though the S&R method has the foregoing advantages, problems described below arise when a large amount of data is analyzed and the gate length of a transistor used in a standard library cell is estimated. These problems are:

(1) An estimation algorithm is complicated and electric effective channel length L_{eff} needs to be calculated after measurement. Accordingly, a large amount of measurement data on the I_{d}−V_{g} characteristic needs to be accumulated and an enormous amount of calculation is required. Therefore, in the case of analyzing a large amount of data, it is difficult to apply the S&R method.

(2) Methods for estimating electric effective channel length L_{eff} are disclosed in references such as reference 1. However, no method for estimating a physical gate length has been found.

(3) The S&R method is used on the assumption that the target device and the reference device exhibit the same carrier mobility. However, as disclosed in reference 2, for example, the carrier mobility changes greatly depending on stress caused by an STI. The amount of this change is inversely proportional to the distance (finger length) from the interface between the STI and an active region to a center of the channel region, as disclosed in reference 3. In a transistor used in a standard library cell, the finger length has an arbitrary value, and thus the carrier mobility in a MIS transistor can take various values. Therefore, electric effective channel length L_{eff} obtained by estimation using the S&R method is affected by the layout dependence of the carrier mobility.

FIGS. 16A through 16C are a plan view showing a layout of a target device, a plan view showing a layout of a reference device and a plan view showing a layout of a standard cell having a complex configuration, respectively. In FIGS. 16A and 16B, FA and FB denote distances each from the interface between an STI and an active region to a center of channel. As shown in FIGS. 16A and 16B, FA<FB, so that μA<μB in an n-MIS transistor and μA>μB in a p-MIS transistor. Accordingly, the assumption that the carrier mobilities immediately under the channels of the respective MIS transistors are the same is not true in itself, and thus the mobility might cause an error in estimating electric effective channel length L_{eff}. As shown in FIG. 16C, in the standard cell having a complex active region, it is necessary to estimate electric effective channel length L_{eff} by correcting the carrier mobility.

### SUMMARY OF THE INVENTION

It is therefore an object of the present invention to provide a method for quickly evaluating a physical parameter of a transistor from electric characteristics of the transistor with high accuracy, based on the finding that the maximum value of transconductance obtained when a gate bias of the transistor is changed hardly changes by a variation of a threshold voltage.

A first method for evaluating a semiconductor device according to the present invention is a method using a first relational expression and a second relational expression. The first relational expression represents a relationship among a gate bias, carrier mobility, an electric effective channel length and transconductance of a transistor. The second relational expression represents a relationship among a maximum-transconductance ratio between a target transistor and a reference transistor and electric effective channel lengths of the respective transistors. In this method, the maximum value of transconductance obtained when a gate bias of the target transistor is changed is determined as the maximum transconductance; and substitution of the value of the maximum transconductance in the second relational expression is performed, thereby estimating the electric effective channel length.

With this method, based on the finding that the maximum value of transconductance obtained when a gate bias of a transistor is changed hardly changes by a variation of a threshold voltage, easy algorithms are used and a short period of time is sufficient for measurement, as compared to a method for obtaining an electric effective channel length using an S&R method. That is, a method for evaluating a semiconductor device suitable for evaluating an electric effective channel length quickly and for evaluating a large amount of data is achieved. Use of this method enables quick monitoring of a process variation of gate length L_{gate}.

In this case, the second relational expression may be obtained by using actually-measured data and the second relational expression may be stored in the storage means.

If a physical gate length of the target transistor is estimated from the calculated electric effective channel length by using a correlation between the electric effective channel length and the physical gate length of the transistor, the physical gate length is easily determined, as a so-called electric gate length, from a transconductance characteristic of the target transistor.

If the carrier mobility of the target transistor is more accurately calculated using layout information and transconductance is corrected, electric effective channel length L_{eff} independent of a layout is calculated, thus enhancing accuracy in estimating the electric effective channel length.

If the value of the maximum transconductance is corrected in accordance with parasitic resistances of source and drain of the target transistor, the accuracy in estimating an electric effective channel length is enhanced. The method for the correction is preferably appropriately selected depending on a layout shape of the target transistor.

A second method for evaluating a semiconductor device according to the present invention is a method utilizing a correlation between an electric effective channel length of a transistor and a physical gate length of the transistor to calculate an electric effective channel length of a target transistor and thereby calculate a physical gate length of the target transistor as an electric gate length.

With this method, if an electric effective channel length of the target transistor is determined by a means, a physical gate length of the target transistor is obtained quickly.

As described above, with a method for evaluating a semiconductor device according to the present invention, an electric effective channel length and an electric gate length are quickly estimated with ease using simple algorithms.

### BRIEF DESCRIPTION OF THE DRAWINGS

FIG. 1 is a graph showing a correlation between the inverse of transconductance and critical-dimension (CD) SEM gate length L_{gsem} of a target device in a sample wafer.

FIG. 2 is a graph showing a result of actual measurement on the gate-bias dependence of transconductance obtained based on a first relational expression.

FIG. 3 is a graph showing a result of a simulation performed to determine how the dependence of transconductance on a gate bias changes when a substrate concentration is varied within the range of a variation in an actual process.

FIG. 4 is a graph showing a relationship between electric effective channel length L_{eff} and CD-SEM gate length L_{gsem}.

FIG. 5 is a graph showing a comparison between electric gate length L_{gate} obtained by a Gₘₘₐₓ method as a combination of first and second embodiments of the present invention and electric gate length L_{gate} obtained by a conventional S&R method.

FIG. 6 is a graph showing data on Vₜₕ roll-off of an n-MIS transistor with CD-SEM gate length L_{gsem} and electric gate length L_{gate} plotted on the abscissa.

FIG. 7 is a graph showing data on Vₜₕ roll-off of a p-MIS transistor with CD-SEM gate length L_{gsem} and electric gate length L_{gate} plotted on the abscissa.

FIG. 8 is a plan view schematically showing a layout of a MIS transistor in which finger lengths are asymmetric.

FIG. 9 is a plan view schematically showing a layout of a MIS transistor in which an active region is not rectangular in the plan view.

FIG. 10 is an equivalent circuit diagram showing a MIS transistor in consideration of parasitic resistance R_{d} of drain and parasitic resistance Rₛ of source.

FIGS. 11A and 11B are plan views schematically showing two examples of transistors with layouts in which gates are of the same shape and active regions are of different shapes and in each of which the shape of source and drain is symmetric with respect to the gate in the plan views.

FIGS. 12A and 12B are plan views schematically showing examples of transistors with layouts in which gates are of the same shape and active regions are of different shapes and in each of which the active region is asymmetric with respect to the gate.

FIG. 13 is an illustration for explaining definitions of dimensions regarding a gate electrode of a MIS transistor.

FIG. 14 is a diagram showing an equivalent circuit including a MIS transistor in consideration of parasitic resistances of drain and source.

FIG. 15 is a graph showing the dependence of the total resistance on the gate length.

FIGS. 16A through 16C are a plan view showing a layout of a target device, a plan view showing a layout of a reference device and a plan view showing a layout of a standard cell having a complex configuration, respectively.

### DESCRIPTION OF THE PREFERRED EMBODIMENTS

Methods for evaluating a semiconductor device which will be described in the following embodiments of the present invention are based on the assumption that all the calculations are conducted by a computer.

### Embodiment 1

Drain current I_{d} in a linear region of a MIS transistor is given by the following equation (20):
I_{d}=(W·μ_{eff}·Cₒ/L_{eff})·{(V_{g}−Vₜₕ)V_{d}−V_{d}²/2} (20)
and transconductance Gₘ, which is obtained by differentiating drain current with respect to a gate voltage, is given by a first relational expression of the following equation (21):
Gₘ=δI_{d}/δV_{g}=(W·μ_{eff}·Cₒ/L_{eff})V_{d} (21)
(where δ means a partial differentiation.)

In this case, drain current I_{d} is inversely proportional to electric effective channel length L_{eff} but threshold voltage Vₜₕ greatly depends on gate length L_{gate}, so that a comparison between the devices is not conducted in a simple manner. In view of this, in a first embodiment of the present invention, in order to minimize an error in estimating electric effective channel length L_{eff} due to a variation of threshold voltage Vₜₕ, maximum value Gₘₘₐₓ (maximum transconductance) of transconductance Gₘ of a target device is calculated so that electric effective channel length L_{eff} of the target device is calculated from the ratio of the calculated maximum value Gₘₘₐₓ to maximum transconductance Gₘₘₐₓ of a reference device in which electric effective channel length L_{eff} can be assumed to be the mask size. That is, a second relational expression of the following equation (22):
L_{eff}=(G_{mmax L=Lref}/G_{mmax L=Ltar})×L_{ref} (22)
is stored in a storage unit. To obtain electric effective channel length L_{eff}, the relational expression of Equation (22) is taken from the storage unit and electric effective channel length L_{eff} is calculated by substituting the values of G_{mmax L=Lref}, G_{mmax L=Ltar} and L_{ref} in Equation (22). The second relational expression (22) may be standardized beforehand depending on the type of a semiconductor device so that a storage unit or a recording medium in/on which Equation (22) has been stored is used.

In this case, it was confirmed, using a sample wafer, that transconductance Gₘₘₐₓ of the target device is substantially inversely proportional to electric effective channel length L_{eff} as expressed by Equation (22).

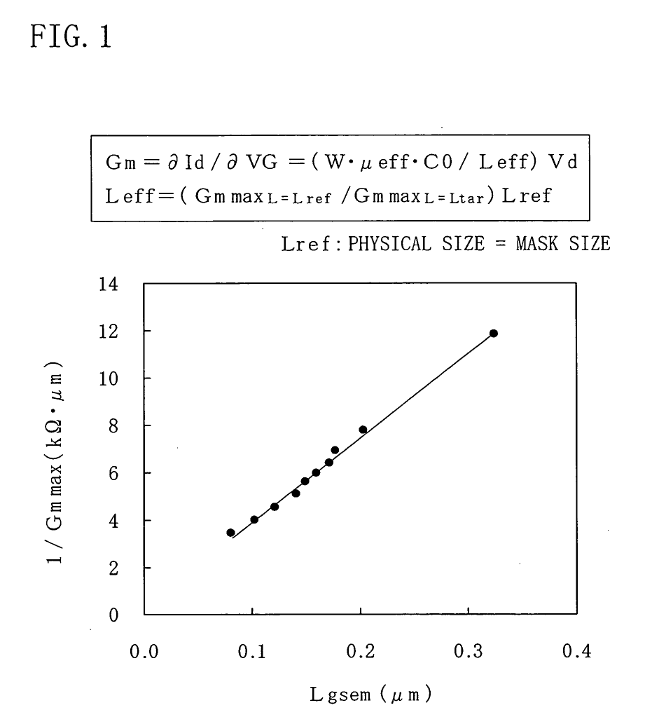

FIG. 1 is a graph showing a correlation between the inverse of transconductance, i.e., 1/Gₘₘₐₓ, and critical-dimension (CD) SEM gate length L_{gsem} of a target device in the sample wafer. As shown in FIG. 1, the inverse of transconductance, 1/Gₘₘₐₓ, and gate length L_{gsem} show a correlation which is strong enough to allow maximum transconductance Gₘₘₐₓ to be used in monitoring a process variation of a physical gate length. That is, electric effective channel length L_{eff} is easily determined based on Equation (22).

It should be noted that the line of 1/Gₘₘₐₓ−L_{gsem} does not pass through the origin of the graph. This is because of the following reason. As the gate length of a transistor decreases, the channel resistance decreases but parasitic resistance R_{sd} is constant. Accordingly, the proportion of parasitic resistance R_{sd} increases as the gate length decreases. Therefore, to evaluate the absolute value of the gate length, it is necessary to correct the influence of parasitic resistance R_{sd} as described in an embodiment below.

Now, a characteristic in which the dependence of maximum transconductance Gₘₘₐₓ on threshold voltage Vₜₕ is extremely small will be described.

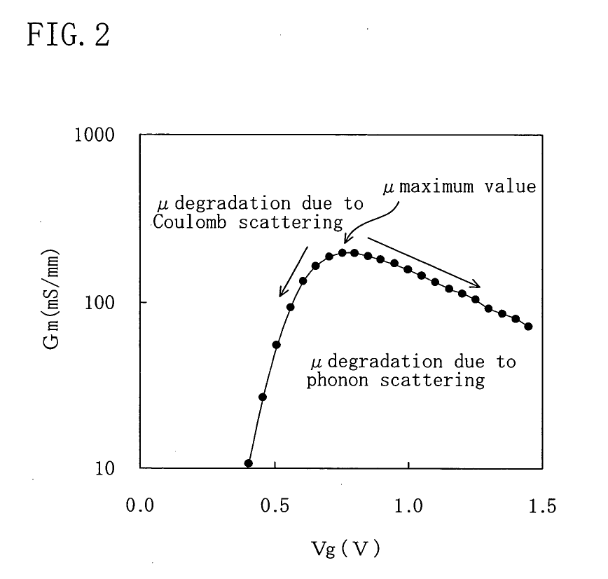

FIG. 2 is a graph showing a result of actual measurement on the dependence of transconductance Gₘ on gate bias V_{g} obtained based on the first relational expression (21). Such dependence of transconductance Gₘ on gate bias V_{g} is explained using the dependence of effective carrier mobility μ_{eff} on gate bias V_{g}.

Specifically, effective carrier mobility μ_{eff} decreases due to Coulomb scattering in a region where gate bias V_{g} is low (Vₜₕ<V_{g}<Vₜₕ+0.3 (V)) whereas effective carrier mobility μ_{eff} deteriorates due to phonon scattering in a region where gate bias V_{g} is high (V_{g}>Vₜₕ+0.3 (V)). Accordingly, transconductance Gₘ has maximum transconductance Gₘₘₐₓ. Effective carrier mobility μ_{eff} depends on a substrate concentration. Specifically, effective carrier mobility μ_{eff} is high at a low substrate concentration and is low at a high substrate concentration. Accordingly, a change in a gate bias causes the presence of a portion where the transconductance is at the maximum. In view of this, the maximum value of this transconductance is determined as maximum transconductance Gₘₘₐₓ.

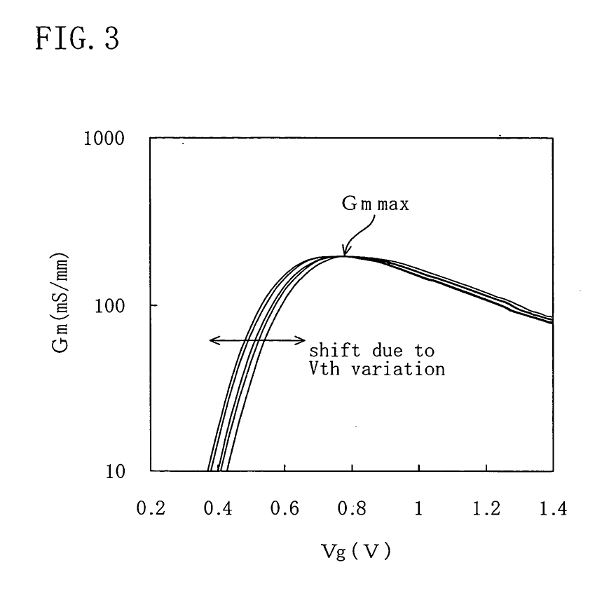

FIG. 3 is a graph showing a result of a simulation performed to determine how the dependence of transconductance Gₘ on gate bias V_{g} changes when the substrate concentration (threshold voltage Vₜₕ) is varied within the range of a variation in an actual process. As shown in FIG. 3, threshold voltage Vₜₕ varies within the range of ±20 mV because of a process variation of the substrate concentration, and the range of the associated change in maximum transconductance Gₘₘₐₓ is ±1.7%. This range of ±1.7% is only due to a change in effective carrier mobility μ_{eff} and is very small as compared to the range of a change in saturation value I_{dsat} of drain current, which is ±6.5%. Therefore, maximum transconductance Gₘₘₐₓ is hardly affected by the influence of a variation of threshold voltage Vₜₕ.

In this embodiment, the maximum transconductance Gₘₘₐₓ obtained when gate bias V_{d} is changed is determined by using the first relational expression (21) showing a relationship among gate bias V_{d}, carrier mobility μ_{eff}, electric effective channel length L_{eff} and transconductance Gₘ and the second relational expression (22) showing a relationship among maximum-transconductance ratio G_{mmax L=Lref}/G_{mmax L=Ltar} between the target transistor and the reference transistor and electric effective channel lengths L_{eff} and L_{ref}. Then, electric effective channel length L_{eff} is estimated by substituting the value of maximum transconductance Gₘₘₐₓ in the second relational expression (22).

A method for obtaining electric effective channel length L_{eff} based on the first and second relational expressions (21) and (22) as described in this embodiment (hereinafter referred to as a “Gₘₘₐₓ method”) uses easy algorithms and requires only a short period of time for measurement, as compared to a method for obtaining electric effective channel length L_{eff} using the S&R method. Accordingly, this method is suitable for estimating an electric effective channel length quickly and for estimating a large amount of data.

### Embodiment 2

The method for estimating electric effective channel length L_{eff} has been described in the first embodiment. However, a technique for converting the estimated length into electric gate length L_{gate} is needed in application to an actual analysis. Hereinafter, this technique and effects thereof will be described. It should be noted that electric gate length L_{gate} in this embodiment is a physical gate length of a transistor estimated through measurement of electric characteristics (especially transconductance) of the transistor. CD-SEM gate length L_{gsem} is a physical gate length of a transistor measured by a CD-SEM.

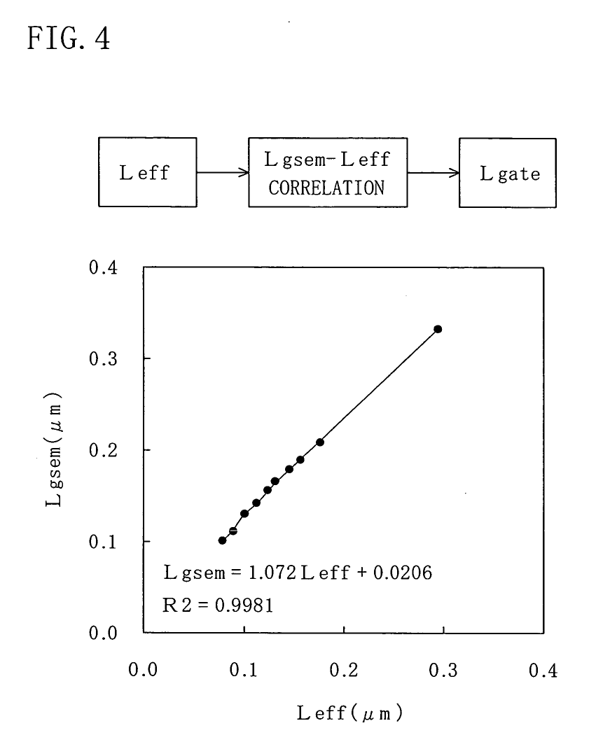

FIG. 4 is a graph showing a relationship between electric effective channel length L_{eff} and CD-SEM gate length L_{gsem}. As CD-SEM gate length L_{gsem}, data obtained by measuring the gate length of a MOS transistor patterned out of a polysilicon film by dry etching is used. As shown in FIG. 4, electric effective channel length L_{eff} and CD-SEM gate length L_{gsem} show a strong correlation. This correlation is also applicable to a different lot as long as a process variation is not significantly large in the same process. A physical gate length measured by another measurement means may be used instead of the CD-SEM gate length.

In this embodiment, the relationship between electric effective channel length L_{eff} and CD-SEM gate length L_{gsem} is grasped beforehand by an experiment and a table or an equation of a line showing a correlation between CD-SEM gate length L_{gsem} and electric effective channel length L_{eff} is created and is stored in a storage unit. Subsequently, electric effective channel length L_{eff} is determined by the method of the first embodiment or another method, and then electric gate length L_{gate}, which is CD-SEM gate length L_{gsem} estimated from electric effective channel length L_{eff}, is determined based on the line shown in FIG. 4 or a relational expression indicated by a line. Specifically, substitution of the value of electric effective channel length L_{eff} in an equation of a line is performed or the value of electric channel length L_{eff} is assigned to most-approximate data by using a table used to create the line. In other words, electric gate length L_{gate} is a physical gate length converted from electric effective channel length L_{eff}.

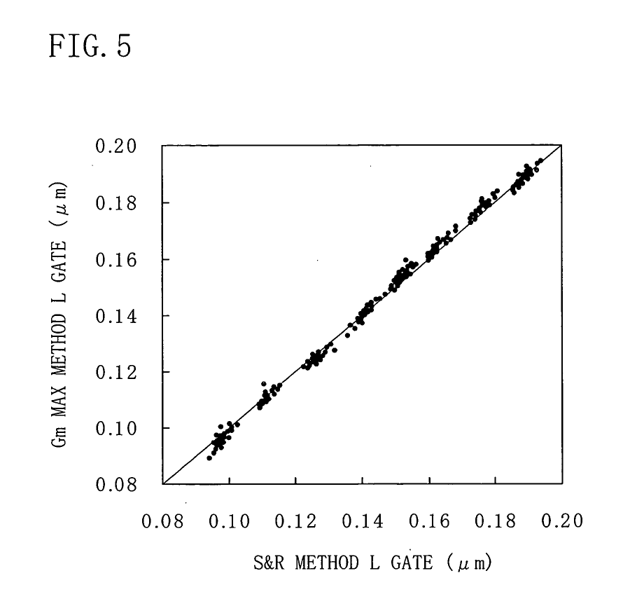

FIG. 5 is a graph showing a comparison between electric gate length L_{gate} obtained by a Gₘₘₐₓ method as a combination of the first and second embodiments and electric gate length L_{gate} obtained by a conventional S&R method. As shown in FIG. 5, electric gate length L_{gate} obtained by the Gₘₘₐₓ method and electric gate length L_{gate} obtained by the conventional S&R method substantially coincide with each other. Accordingly, with the Gₘₘₐₓ method, electric gate length L_{gate} is easily measured with an accuracy almost as high as that obtained by the S&R method.

That is, it is shown that if a correlation between electric effective channel length L_{eff} and CD-SEM gate length L_{gsem} measured with a physical method is once grasped, electric gate length L_{gate} can be obtained from electric effective channel length L_{eff} in transistors fabricated under the same processing conditions.

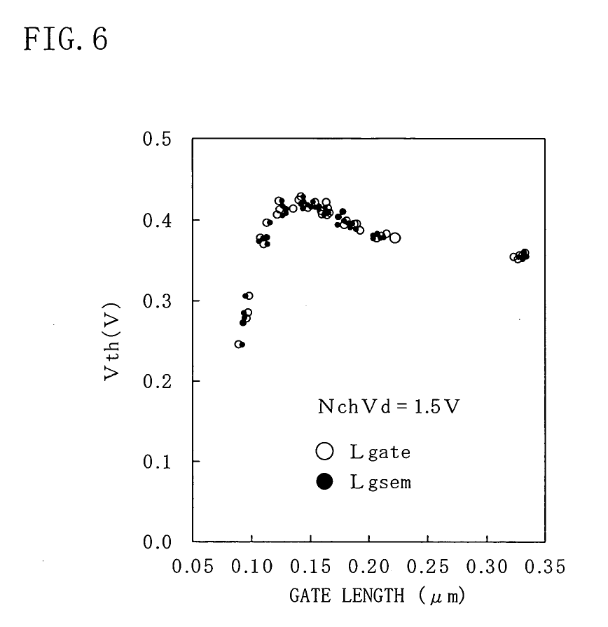

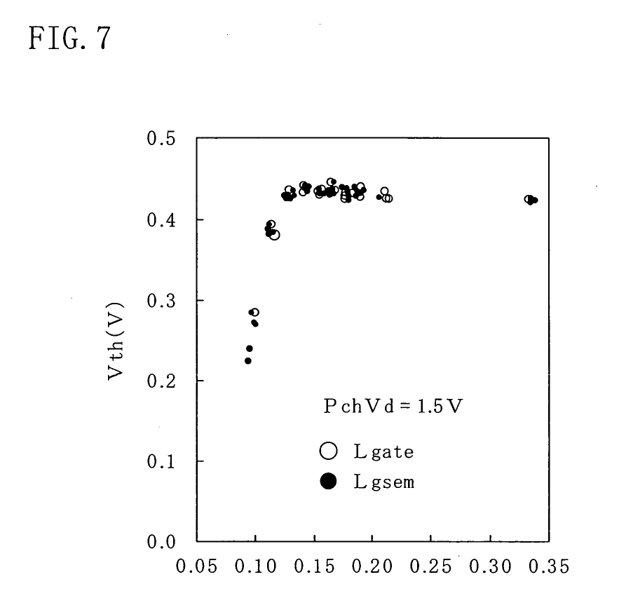

FIG. 6 is a graph showing data on Vₜₕ roll-off of an n-MIS transistor with CD-SEM gate length L_{gsem} and electric gate length L_{gate} plotted on the abscissa. The roll-off herein means a characteristic in which threshold voltage Vₜₕ gradually decreases as gate length L_{g} decreases. FIG. 7 is a graph showing data on Vₜₕ roll-off of a p-MIS transistor with CD-SEM gate length L_{gsem} and electric gate length L_{gate} plotted on the abscissa. FIGS. 6 and 7 both show data obtained when drain voltage V_{d} is 1.5V.

As shown in FIGS. 6 and 7, the Vₜₕ roll-off characteristic of electric gate length L_{gate} estimated from electric effective channel length L_{eff} by the method of this embodiment is almost the same as CD-SEM gate length L_{gsem}. Accordingly, the method of this embodiment is effectively applicable to actual devices.

### Embodiment 3

Now, a technique for estimating the gate length of a transistor used in a standard library cell will be described.

As described in reference 3, suppose a is a finger length (the distance from the interface between an STI and an active region to a gate end), aₘᵢₙ is a minimum design rule of the finger length, a₀ is an equivalent finger length converted from stress caused by a nitride film, a silicide film and others, and U₀₍ₐ₎ is carrier mobility when the finger length is a. U₀₍ₐ₎ is the sum of a component inversely proportional to finger length a and a constant component independent of finger length a (stress independent of a nitride film, a silicide film and others), and thus the following equation (23) is established
U₀₍ₐ₎/U₀₍ₐₘᵢₙ₎=(1/a+1/a₀)/(1/aₘᵢₙ+1/a₀) (23)

If Equation (24) is determined as follows:
V_{mu0(W,L)}=−a/(a₀+aₘᵢₙ) (24)
Equation (23) is altered as the following equation (25):
U₀₍ₐ₎=U₀₍ₐₘᵢₙ₎[1+V_{mu0(W,L)}(a−aₘᵢₙ)/a] (25)

Equation (25) is applicable to a case where finger lengths are asymmetric or an active region is not rectangular (i.e., a rectangle having a cut-away portion) in a plan view.

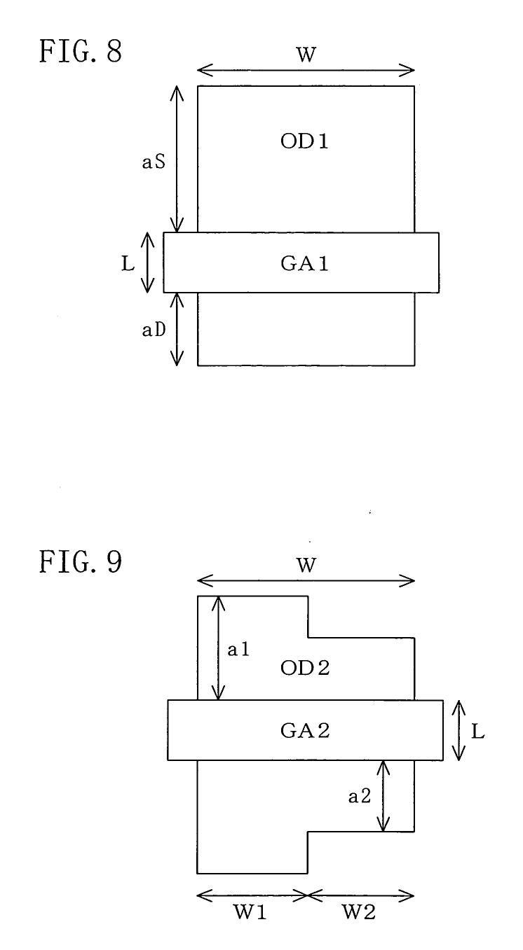

FIGS. 8 and 9 are plan views schematically showing layouts of MIS transistors in each of which finger lengths are asymmetric and an active region is not rectangular in the plan view, respectively. In FIGS. 8 and 9, OD1 and OD2 respectively denote layout patterns of active regions, GA1 and GA2 respectively denote layout patterns of gates, L and W denote the gate length and the gate width, respectively, in each transistor, aS and aD denote finger lengths of source and drain, respectively, W1 and W2 denote gate widths in a case where the active region is a rectangle having cut-away portions in the plan view, and a1 and a2 denote a larger finger length and a smaller finger length, respectively, in the case where the active region is a rectangle having cut-away portions in the plan view.

In the case of FIG. 9, it is sufficient to conduct estimation by the following equations (26) and (27):
U_{0(aeq)}=[U₀₍ₐ₁₎+U₀₍ₐ₂)W₂]/W (26)
1/a_{eq}=W₁/(W·a₁)+W₂/(W·a₂) (27)

In this embodiment, U₀₍ₐ₎ in Equation (23) is used as effective carrier mobility μ_{eff} in Equation (21), so that carrier mobility μ_{eff} for calculating maximum transconductance Gₘₘₐₓ is corrected based on layout information. Specifically, relationships expressed by Equations (21) and (23) are stored in a storage unit and layout information stored in the storage unit and the relational expressions of Equations (21) and (23) stored in the storage unit are taken out, thereby calculating electric effective channel length L_{eff} using the corrected carrier mobility. Accordingly, even in such a case where the active region is a rectangle having cut-away portions in a plan view, for example, an error in the carrier mobility resulting from a layout (i.e., the dependence of the mobility on the layout) is corrected, so that electric effective channel length L_{eff} is estimated more accurately in the first embodiment and the accuracy in estimating electric gate length L_{gate} is enhanced in the second embodiment.

### Embodiment 4

In a fourth embodiment of the present invention, a technique for estimating transconductance Gₘ in consideration of source resistance Rₛ and drain resistance R_{d} will be described.

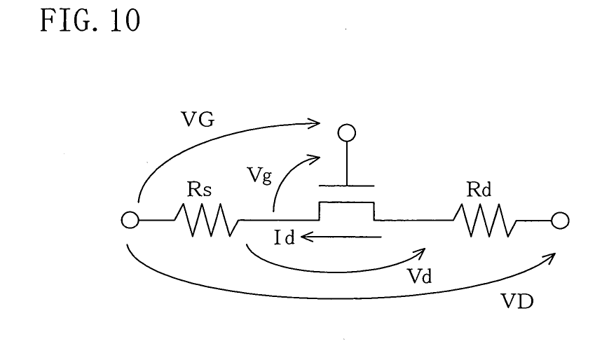

FIG. 10 is an equivalent circuit diagram showing a MIS transistor in consideration of parasitic resistance R_{d} of drain and parasitic resistance Rₛ of source. In FIG. 10, Rₛ and R_{d} are parasitic resistances of source and drain, respectively, VG and VD are a gate voltage and a drain voltage, respectively, applied from the outside, V_{g} and V_{d} are a gate voltage and a drain voltage inside the transistor, and I_{d} is drain current.

In this case, externally-applied drain voltage VD and externally-applied gate voltage VG are respectively given by the following equations (28) and (29):
VD=V_{d}+(Rₛ+R_{d})I_{d} (28)
VG=V_{g}+Rₛ·I_{d} (29)
As described above, drain current I_{d} is given by the following equations (30) and (31):
I_{d}=β(V_{g}−Vₜₕ)V_{d} (30)
β=W·μ_{eff}·Cₒₓ/L_{eff} (31)
Transconductance Gₘ actually measured is given by the following equation (32)
Gₘ=δI_{d}/δVG (32)
(where δ means a partial differentiation.) Pure transconductance Gₘ′ inside the transistor is given by the following equation (33):

$$\begin{matrix}{G}_{m}^{′} = \frac{δ {I}_{d}}{δ {V}_{g}} \\ = β \cdot {V}_{d}\end{matrix} \qquad ( 33 )$$

Accordingly, in consideration of Equations (28) and (29), the following equations (34) and (35) are established
δI_{d}/δVG=−(Rₛ+R_{d})*Gₘ (34)
δV_{g}/δVG=1−Rₛ·Gₘ (35)
Accordingly, if transconductance Gₘ is calculated based on the above definitions,

$$\begin{matrix}{G}_{m} = \frac{δ {I}_{d}}{δ {V}_{g}} \\ = β [ ( {V}_{g} - {V}_{th} ) ( \frac{δ VD}{δ {V}_{g}} ) + {V}_{d} [ ( \frac{δ {V}_{g}}{δ {V}_{g}} ) ] \\ = β [ - ( {R}_{s} + {R}_{d} ) {G}_{m} ( {V}_{g} - {V}_{th} ) + ( 1 - {R}_{s} \cdot {G}_{m} ) {V}_{d} ] \\ = β \cdot {V}_{d} - β \cdot {R}_{s} \cdot {G}_{m} \cdot {V}_{d} - ( {R}_{s} + {R}_{d} ) \cdot {G}_{m} \cdot β \cdot ( {V}_{g} - {V}_{th} ) \\ = β \cdot {V}_{d} - β \cdot {R}_{s} \cdot {G}_{m} \cdot {V}_{d} - ( {R}_{s} + {R}_{d} ) \cdot {G}_{m} \cdot ( \frac{{I}_{d}}{{V}_{d}} )\end{matrix} \qquad ( 3 )$$

If Equation (36) is rearranged with respect to Gₘ, the following equation (37) is established

$$\begin{matrix}{G}_{m} = β \cdot \frac{{V}_{d}}{[ 1 + {R}_{s} \cdot β \cdot {V}_{d} + ( {R}_{s} + {R}_{d} ) ( \frac{{I}_{d}}{{V}_{d}} ) ]} \\ = \frac{{G}_{m}^{′}}{[ 1 + {R}_{s} \cdot {G}_{m}^{′} + ( {R}_{s} + {R}_{d} ) ( \frac{{I}_{d}}{{V}_{d}} ) ]}\end{matrix} \qquad ( 37 )$$

Accordingly, pure Gₘ′ inside the transistor is given by the following equation (38):
Gₘ′=Gₘ[1+(Rₛ+R_{d})(I_{d}/V_{d})]/[1−Rₛ·Gₘ] (38)

In this embodiment, maximum transconductance Gₘₘₐₓ is calculated more accurately with an error caused by parasitic resistances corrected, by the following equations (39):
Gₘₘₐₓ′=Gₘₘₐₓ[1+(Rₛ+R_{d})(I_{d}/V_{d})]/[1−Rₛ·Gₘₘₐₓ] (39)
where Rₛ is a parasitic resistance of source of the transistor and R_{d} is a parasitic resistance of drain of the transistor. Accordingly, electric effective channel length L_{eff} is estimated more accurately in the first embodiment and the accuracy in estimating electric gate length L_{gate} is enhanced in the second embodiment.

### Embodiment 5

In a fifth embodiment of the present invention, a technique for estimating source/drain resistance Rₛ/R_{d} in a case where an active region has a symmetrical shape.

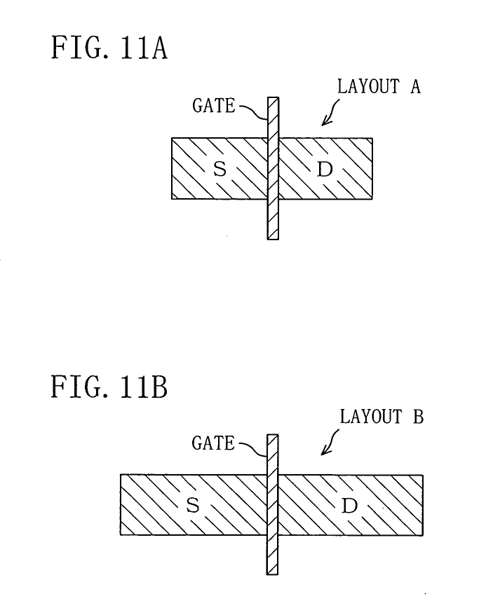

FIGS. 11A and 11B are plan views schematically showing two examples of transistors with layouts A and B in which gates are of the same shape and active regions are of different shapes and in each of which the shape of source and drain is symmetric with respect to the gate in the plan view.

Internal maximum tranconductances Gₘ′_A and Gₘ′_B in layouts A and B are given by the following equations (40) and (41):
Gₘ′_{—}A=β_{—}A·V_{d}=W·μ_{eff}_{_{—}}A·Cₒₓ/L_{eff} (40)
Gₘ′_{—}B=β_{—}B·V_{d}=W·μ_{eff}_{_{—}}B·Cₒₓ/L_{eff} (41)
where I_{d}_{_{—}}A and I_{d}_{_{—}}B are actually-measured values of drain current in layouts A and B, respectively, Gₘ_{_{—}}A and Gₘ_{_{—}}B are actually-measured values of maximum transconductance Gₘₘₐₓ in layouts A and B, respectively, and μ_{eff}_{_{—}}A and μ_{eff}_{_{—}}B are carrier mobilities in layouts A and B, respectively. Suppose drain parasitic resistance R_{d} is equal to source parasitic resistance Rₛ in layouts A and B. Then, since the layout shape of the active region is symmetric, substitution of R_{d}=Rₛ is conducted as

$$\frac{{G}_{m\_}^{′} A}{{G}_{m\_}^{′} B} = \frac{{μ}_{eff\_} A}{{μ}_{eff\_} B} = \frac{[ {G}_{m\_} A \{ \frac{1 + 2 {R}_{s} ( \frac{{I}_{d\_} A}{{V}_{d}} )}{\{ 1 - {R}_{s} \cdot {G}_{m\_} A \}} \} ]}{[ \frac{{G}_{m\_} B \{ 1 + 2 {R}_{s} ( \frac{{I}_{d\_} B}{{V}_{d}} ) \}}{\{ 1 - {R}_{s} \cdot {G}_{m\_} B \}} ]} \qquad ( 42 )$$

From Equation (42), source/drain parasitic resistance Rₛ/R_{d} is estimated from the ratio between internal maximum tranconductances Gₘ′_A and Gₘ′_B in layouts A and B.

Specifically, suppose in two transistors with layouts in which gates are of the same shape and active regions are of different shapes and in each of which the shape of source and drain is symmetric with respect to the gate in the plan view, parasitic resistances Rₛ and R_{d} are equal to each other. Then, with a technique for estimating parasitic resistance Rₛ from the ratio between internal values of maximum transconductances Gₘₘₐₓ, parasitic resistances Rₛ and R_{d} are determined quickly. An error caused by the fact that the line of 1/Gₘₘₐₓ−L_{gsem} in FIG. 1 does not pass through the origin can be disregarded. Consequently, electric effective channel length L_{eff} is estimated more accurately in the first embodiment and the accuracy in estimating electric gate length L_{gate} is enhanced in the second embodiment.

Now, a method for estimating source/drain parasitic resistances Rₛ and R_{d} in a case where the shape of an active region is asymmetric will be described.

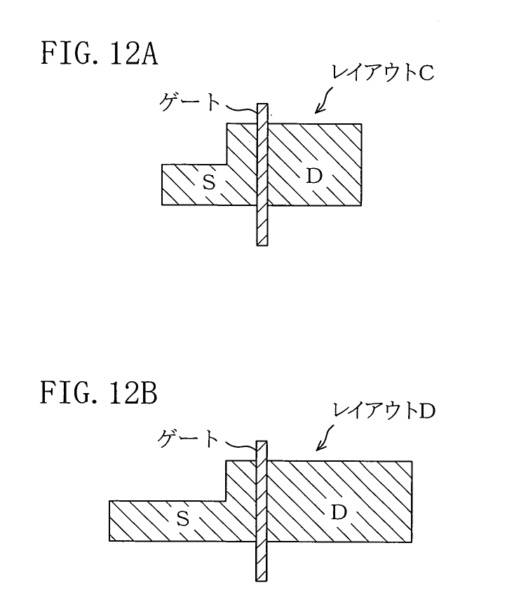

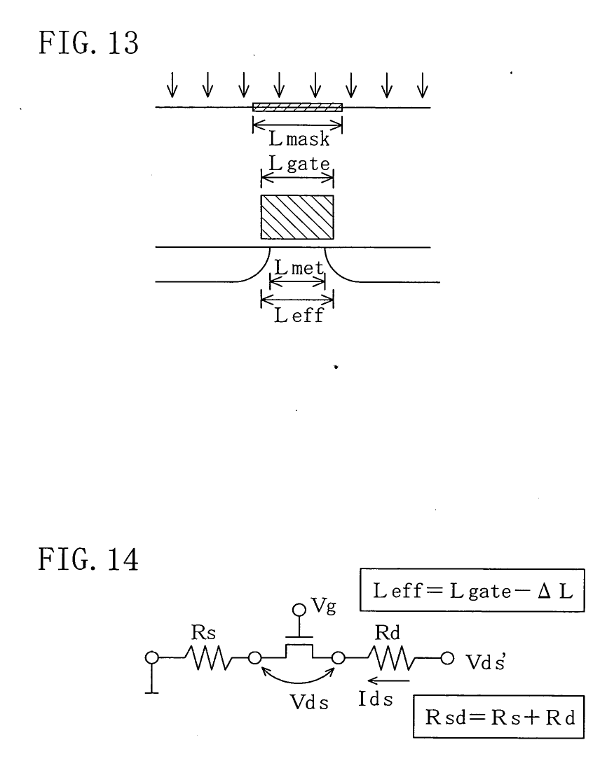

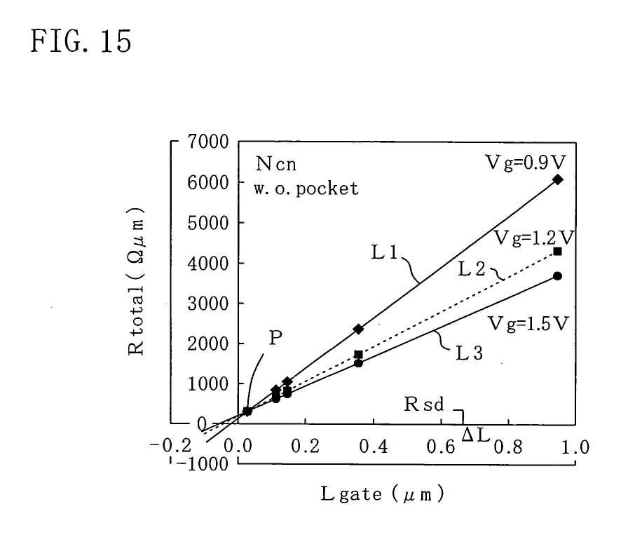

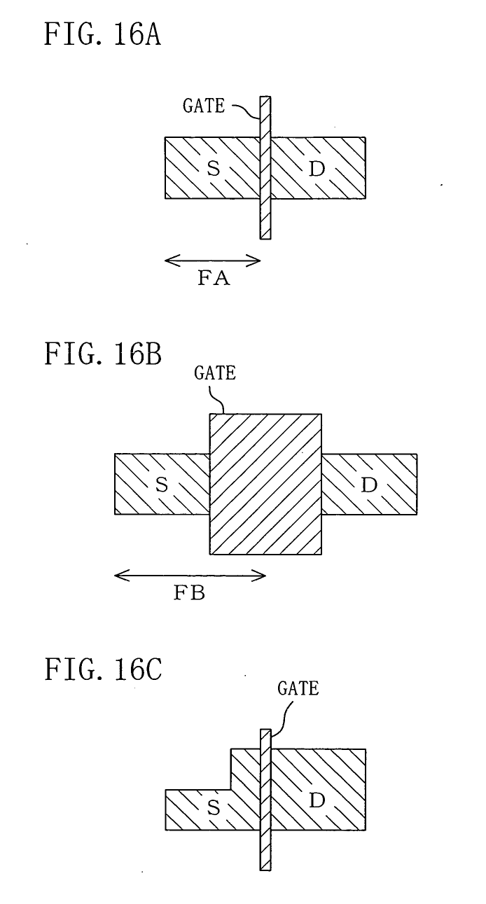

FIGS. 12A and 12B are plan views schematically showing examples of transistors with layouts C and D in which gates are of the same shape and active regions are of different shapes and in each of which the active region is asymmetric with respect to the gate. As shown in FIGS. 12A and 12B, the shape of each active region is asymmetric with respect to the gate.

Internal maximum tranconductances Gₘ′_C and Gₘ′_D are given by the following equations (43) and (44):

$$\begin{matrix}\frac{{G}_{m}^{′} \_C \_for}{{G}_{m}^{′} \_D \_for} = \frac{[ {G}_{m} \_C \_for \frac{\{ 1 + ( {R}_{s} + {R}_{d} ) ( \frac{{I}_{d} \_C \_for}{{V}_{d}} ) \}}{\{ 1 - {R}_{s} \cdot {G}_{m} \_C \_for \}} ]}{[ \frac{{G}_{m} \_D \_for \{ 1 + ( {R}_{s} + {R}_{d} ) ( \frac{{I}_{d} \_D \_for}{{V}_{d}} ) \}}{\{ 1 - {R}_{s} \cdot {G}_{m} \_D \_for \}} ]} & ( 43 ) \\ \frac{{G}_{m}^{′} \_C \_rev}{{G}_{m}^{′} \_D \_rev} = \frac{[ {G}_{m} \_C \_rev \frac{\{ 1 + ( {R}_{d} + {R}_{s} ) ( \frac{{I}_{d} \_C \_rev}{{V}_{d}} ) \}}{\{ 1 - {R}_{d} \cdot {G}_{m} \_C \_rev \}} ]}{[ \frac{{G}_{m} \_D \_rev \{ 1 + ( {R}_{d} + {R}_{s} ) ( \frac{{I}_{d} \_D \_rev}{{V}_{d}} ) \}}{\{ 1 - {R}_{d} \cdot {G}_{m} \_D \_rev \}} ]} & ( 44 )\end{matrix}$$

where I_{d}_{_{—}}C_for and I_{d}_{_{—}}D_for are actually-measured values of forward drain current in layouts C and D, respectively, I_{d}_{_{—}}C_rev and I_{d}_{_{—}}D_rev are actually-measured values of backward drain current in layouts C and D, respectively, between which source and drain are replaced with each other, Gₘ_{_{—}}C_for and Gₘ_{_{—}}D_for are actually-measured values of Gₘₘₐₓ with respect to forward drain current in the layouts C and D, respectively, Gₘ_{_{—}}C_rev and Gₘ_{_{—}}D_rev are actually-measured values of Gₘₘₐₓ with respect to backward drain current in the layouts C and D, respectively, and Rₛ and R_{d} are parasitic resistances of source and drain, respectively, in layouts C and D. Accordingly, parasitic resistances Rₛ and R_{d} are estimated from the ratio between internal values of two types of Gₘₘₐₓ obtained in the layouts between which direction of source and drain is switched, as expressed by Equations (43) and (44).

Specifically, with a technique for estimating parasitic resistances Rₛ and R_{d} from the ratio between actually-measured internal values of two types of Gₘₘₐₓ in layouts between which the direction of source and drain is switched, parasitic resistances Rₛ and R_{d} are obtained quickly. An error caused by the fact that the line of 1/Gₘₘₐₓ−L_{gsem} in FIG. 1 does not pass through the origin can be disregarded. Consequently, electric effective channel length L_{eff} is estimated more accurately in the first embodiment and the accuracy in estimating electric gate length L_{gate} is enhanced in the second embodiment.

The present invention is applicable to evaluation of characteristics of a MIS transistor in LSI incorporated in various electric devices.

1. A method for evaluating a semiconductor device using storage means for storing a first relational expression and a second relational expression, the first relational expression representing a relationship among a gate bias, carrier mobility, an electric effective channel length and transconductance of a transistor, the second relational expression representing a relationship among a maximum-transconductance ratio between a target transistor and a reference transistor and electric effective channel lengths of the respective transistors, the method comprising the steps of:
(a) taking the first relational expression from the storage means and determining, as the maximum transconductance, the maximum value of transconductance obtained when a gate bias of the target transistor is changed; and
(b) taking the second relational expression from the storage means and substituting the value of the maximum transconductance of the target transistor determined in the step (a) in the second relational expression, thereby estimating the electric effective channel length of the target transistor.

2. The method of claim 1, further comprising the step of obtaining the second relational expression using actually-measured data and storing the second relational expression in the storage means, before the step (a) is performed.

3. The method of claim 1, wherein the storage means stores a correlation between an electric effective channel length of a transistor and a physical gate length of the transistor, and
the method further comprises the step (c) of taking the correlation from the storage means and substituting the electric effective channel length calculated in the step (b) in the correlation, thereby estimating a physical gate length of the target transistor.

4. The method of claim 1, wherein the storage means stores layout information,
the method further comprises the step (d) of taking layout information on the target transistor from the storage means and calculating the carrier mobility of the target transistor based on a layout, and
in the step (a), the carrier mobility calculated in the step (d) is used as the carrier mobility in the first relational expression.

5. The method of claim 1, wherein in the step (a), maximum transconductance in which an error caused by a parasitic resistance in the target transistor is corrected is given by the following equation (A):
Gₘ′=Gₘₘₐₓ[1+(Rₛ+R_{d})(I_{d}/V_{d})]/[1−Rₛ·Gₘₘₐₓ] (A)
where V_{d} is a voltage applied between a source and a drain of the target transistor, I_{d} is a current value obtained when the transconductance of the target transistor has a maximum value Gₘₘₐₓ, and Rₛ and R_{d} are parasitic resistances in the source and the drain, respectively, of the target transistor.

6. The method of claim 5, wherein in the step (a), the parasitic resistances Rₛ and R_{d} are estimated from a Gₘ′ ratio between two target transistors based on the assumption that the target transistors have gates of the same shape and active regions of different shapes and the shape of the source and the drain in the active region of each of the transistors is symmetric with respect to the gate in a plan view.

7. The method of claim 5, wherein in the step (a), the parasitic resistances Rₛ and R_{d} are estimated from two types of Gₘ′ ratios with respect to forward drain current and backward drain current in two target transistors which have gates of the same shape and active regions of different shapes and in each of which the shape of the source and the drain in the active region is asymmetric with respect to the gate in a plan view.

8. A method for evaluating a semiconductor device using storage means for storing a correlation between an electric effective channel length of a transistor and a physical gate length of the transistor, the method comprising the steps of:
(a) calculating an electric effective channel length of a target transistor: and
(b) taking the correlation from the storage means and substituting the electric effective channel length calculated in the step (a) in the correlation, thereby calculating a physical gate length of the target transistor as an electric gate length.
